(19) United States
(12) Patent Application Publication
(10) Pub. No.: US 2026/0360386 A1
(43) Pub. Date: Nov. 12, 2026

(54) Dual Pole Tip Writer Design For Improved Magnetic Recording Aerial Density Capability

(71) Applicant: Headway Technologies, Inc., Milpitas, CA (US)

(72) Inventors: Yue Liu, Fremont, CA (US); Shehrin Sayed, Fremont, CA (US)

(21) Appl. No.: 19/203,040

(22) Filed: May 8, 2025

(51) Int. Cl. G11B 5/127; G11B 5/23; G11B 5/48

(52) U.S. Cl. CPC G11B 5/1278; G11B 5/232; G11B 5/4833

(57) ABSTRACT

The present embodiments describe write head designs with two pole tips (e.g., a dual pole tip (DPT)) connected inside the A BS and separated by a write gap (WG) near the ABS. The design can include a first tip (Tip1) that can remain the primary writing main pole (MP) tip, while a second tip (Tip2) acts as the booster to enhance MP field of Tip1 and adjust MP field edge quality of Tip1. With MP field enhancement, the write head can match media with smaller grain size and higher coercivity and improve both CMR and SMR ADC.

### TECHNICAL FIELD

Embodiments of the invention relate to the field of electro-mechanical data storage devices. M ore particularly, embodiments of the invention relate to the field of a perpendicular magnetic recording (PM R) write head for a hard disk drive (HDD).

### BACKGROUND

Volumes of digital data can be stored on a disk drive, such as a Hard disk drive (HDD) device. The disk drive can comprise a head that can interact with a magnetic recording medium (e.g., a disk) to read and write magnetic data onto the disk. For instance, the disk drive can include a write head that is positioned near the disk and can modify a magnetization of the disk passing immediately under the write head.

As the overall amount of digital data being stored on HDD devices increases, there is an increasing demand for greater data capacity of HDD devices. Disk drives can utilize various technologies to write to a disk. For example, perpendicular magnetic recording (PM R) can relate to magnetic bits on a disk are directed perpendicular (e.g., either up or down) relative to the disk surface. PMR recording can increase storage density to the disk by aligning poles of magnetic elements on the disk perpendicularly to the surface of the disk.

While developments have been made, further innovation is needed.

### SUMMARY

The present embodiments describe write head designs with two pole tips (e.g., a dual pole tip (DPT)) connected inside an air-bearing surface (ABS) and separated by a write gap (WG) near the A BS. The design can include a first tip (Tip1) that can remain the primary writing main pole (MP) tip, while a second tip (Tip2) acts as the booster to enhance MP field of Tip1 and adjust M P field edge quality of Tip1. With MP field enhancement, the write head can match media with smaller grain size and higher coercivity and improve both conventional magnetic recording (CMR) and shingled magnetic recording (SMR) aerial density capability (ADC).

In a first example embodiment, a write head is provided. The write head can include a main pole (MP) configured to be disposed at an air-bearing surface (ABS). The MP can include a first tip (Tip1) portion configured as a primary writing tip and a second tip (Tip2) portion acting as a booster to enhance a magnetic field of the first tip portion. The write head can also include a write gap (WG) formed between the first tip portion and the second tip portion, a write shield (WS) disposed on a top side of the M P, a side shield (SS) disposed at left and right sides of the M P, and a leading shield (LS) disposed at a bottom side of the MP. The write head can also include a trailing gap (TG) between the WS and the second tip portion of the M P, two side gaps (SG) between SS and the first tip portion of the MP, and a leading gap (LG) between the LS and the first tip portion of the MP.

In some instances, the WG comprises a trapezoidal shape.

In some instances, the WG comprises a rectangular shape with a length of the WG greater than a thickness of the WG.

In some instances, the WG comprises an angled shape with a length of the WG greater than a thickness of the WG.

In some instances, the WG comprises a thickness ranging between around 15-25 nanometers (nm).

In some instances, a thickness of the first tip portion ranges between around 50-100 nm and a thickness of the second tip portion ranges between around 30-80 nm.

In some instances, any of the WG, TG, SG, and LG comprise a non-conductive oxide layer, and the non-conductive oxide layer comprises any of aluminum oxide (AlOx), silicon oxide (SiOx), silicon nitride (SiN), aluminum nitride (AlN), magnesium oxide (MgO), titanium oxide (TiOx) and tantalum oxide (TaOx).

In some instances, any of the WG, TG, SG, and LG comprise a conductive non-magnetic metallic layer that comprises any of Ruthenium (Ru), Nichrome (NiCr), Platinum (Pt), Platinum-chromium (PtCr), Tantalum (Ta), and Titanium (Ti).

In some instances, any of the LG, SG and TG comprise a combination of a conductive non-magnetic metallic layer and a non-conductive oxide layer comprising a thickness less than that of the conductive non-magnetic metallic layer.

In another example embodiment, a device is provided. The device can include a main pole (MP) comprising a first tip portion and a second tip portion disposed adjacent to the first tip portion. The device can also include a write gap (WG) formed between the first tip portion and the second tip portion. The device can also include a trailing gap (TG) disposed adjacent to the second tip portion of the M P, two side gaps (SG) disposed adjacent to the first tip portion of the MP, and a leading gap (LG) disposed adjacent to the first tip portion of the MP.

In some instances, the device also includes a write shield (WS) disposed adjacent to the TG, two side shields (SS) disposed adjacent to the two SGs and a leading shield (LS) disposed adjacent to the LG.

In some instances, the WG comprises a trapezoidal shape.

In some instances, the WG comprises a rectangular shape with a length of the WG greater than a thickness of the WG.

In some instances, any of the WG, TG, SG and LG comprise a non-conductive oxide layer or conductive non-magnetic metallic layer.

In some instances, the WG comprises the non-conductive oxide layer and the TG, SG and LG comprise conductive non-magnetic metallic layers.

In some instances, the WG comprises the conductive non-magnetic metallic layer and the TG, SG and LG comprise non-conductive oxide layers.

In another example embodiment, a method is provided. The method can include forming a main pole (MP). Forming the M P can include forming a first tip portion of the MP and depositing a write gap (WG) over the surface of the main pole. Forming the MP can also include forming a second tip portion of the MP as being disposed over the WG, patterning the second tip portion by any of a dry film deposition or a chemical mechanical planarization process, and forming a trailing edge taper on the M P. The method can also include disposing a leading gap (LG) adjacent to the first tip portion of the MP, disposing two side gaps (SG) adjacent to the first tip portion of the MP, and disposing a trailing gap (TG) adjacent to the second tip portion of the MP. The method can also include disposing a write shield (WS) adjacent to the TG, side shields (SS) adjacent to the SG, and disposing a leading shield (LS) adjacent to the LG.

In some instances, any of the WG, TG, SG and LG comprise a non-conductive oxide layer, wherein the non-conductive oxide layer comprises any of aluminum oxide (AIOx), silicon oxide (SiOx), silicon nitride (SiN), aluminum nitride (AlN), magnesium oxide (MgO), titanium oxide (TiOx) and tantalum oxide (TaOx), and, wherein any of the WG, TG, and LG comprise a conductive non-magnetic metallic layer that comprises any of Ruthenium (Ru), Nichrome (NiCr), Platinum (Pt), Platinum-chromium (PtCr), Tantalum (Ta), and Titanium (Ti).

In some instances, the method can also include patterning the WG to form the WG into any of a trapezoidal shape and a rectangular shape.

In some instances, any of the LG, SG, and TG comprise a combination of a conductive non-magnetic metallic layer and a non-conductive oxide layer comprising a thickness less than that of the conductive non-magnetic metallic layer.

Other features and advantages of embodiments of the present invention will be apparent from the accompanying drawings and from the detailed description that follows.

### BRIEF DESCRIPTION OF THE DRAWINGS

Embodiments of the present invention are illustrated by way of example and not limitation in the figures of the accompanying drawings, in which like references indicate similar elements and in which:

FIGS. 1A-1F illustrate example air bearing surface (ABS) views of write heads according to an embodiment.

FIGS. 2A-2E illustrate cross-section views of write head designs according to an embodiment.

FIGS. 3A-3B illustrate graphical representations of example areal density capability (ADC) and overwritability (OW2) dependency on writing erase width (EW) for various write head designs according to an embodiment.

FIGS. 4A-4B illustrate example magnetic field lines of one bar magnet and two bar magnets in parallel mode according to an embodiment.

FIG. 5 is an example representation of a down track Hy profile comparison between a single pole tip (SPT) and a dual pole tip (DPT) according to an embodiment.

FIGS. 6A-6G illustrate ABS views of different DPT designs according to an embodiment.

FIGS. 7A-7G illustrate views of an example Flat DPT design according to an embodiment.

FIGS. 8A-8F illustrate example views of a Wrench DPT design according to an embodiment.

FIGS. 9A-9L illustrate views of example antenna DPT write head designs according to an embodiment.

FIGS. 10A-10F illustrate example taper DPT designs according to an embodiment.

FIGS. 11A-11B illustrates DPT gain over SPT in A DC and OW2 according to an embodiment.

FIG. 12 is a perspective view of an example head arm assembly, according to some embodiments.

FIG. 13 is side view of an example head stack assembly, according to some embodiments.

FIG. 14 is a plan view of an example magnetic recording apparatus, according to some embodiments.

### DETAILED DESCRIPTION

Disk drives can utilize various technologies to write to a disk. For example, perpendicular magnetic recording (PM R) can relate to magnetic bits on a disk are directed perpendicular (e.g., either up or down) relative to the disk surface. PMR recording can increase storage density to the disk by aligning poles of magnetic elements on the disk perpendicularly to the surface of the disk.

Further, a disk drive head can include a main pole (MP) with a tip portion configured to be disposed near the surface of the disk. The distance between the main pole tip portion and the disk can be controlled by a dynamic fly height (DFH) writer heater. Particularly, DFH writer heater can heat a portion of the head, causing the M P to expand or contract, thereby modifying the distance between the main pole tip portion and the disk. Electrical energy can be provided to any of the DFH writer heater and the M P tip portion via electrical pads, forming a circuit in the head.

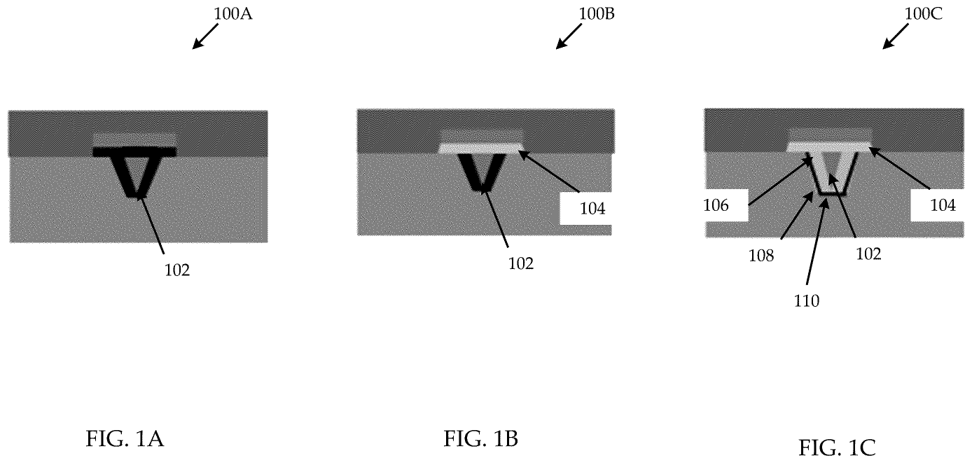

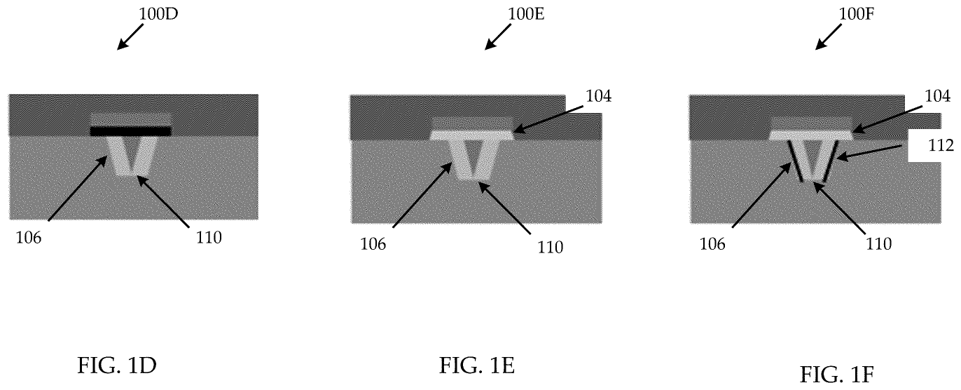

In comparison to a no-bias assist writer, various tunable pole performance (TPP) designs have been proposed to improve areal density capability (ADC) through enhancement of high frequency writing quality by passing a direct current (DC) through MP tip. FIGS. 1A-1F illustrate example air bearing surface (ABS) views of write heads 100A-F. FIG. 1A illustrates a first write head design 100A with a current flowing to a main pole (MP) 102 with no bias assist.

FIGS. 1B-1F illustrate TPP designs with conducting path through the write gap (WG). In FIG. 1B, a design 100B can allow for current to flow from the WS to the M P 102 via a write gap (WG) 104. In FIG. 1C, another design 100C can include a current flowing through the WG 104 and a partial side gap (SG) 106 and leading gap (LG) 110. Further, a thin insulation layer 108 can be disposed around the SG 106 and the LG 110. In FIG. 1D, another design 100D can include a current flowing through the SG 106 and a LG 110. In FIG. 1E, another design 100E can include a current flowing through the WG 104, SG 106, and LG 110, which can be referred to as a combo TPP (or cTPP) design. In FIG. 1F, another design 100F can include a current flowing through the WG 104, SG 106, and LG 110 with a partial thin insulation layer 112, which can be referred to as a cTPP design with insulated SG.

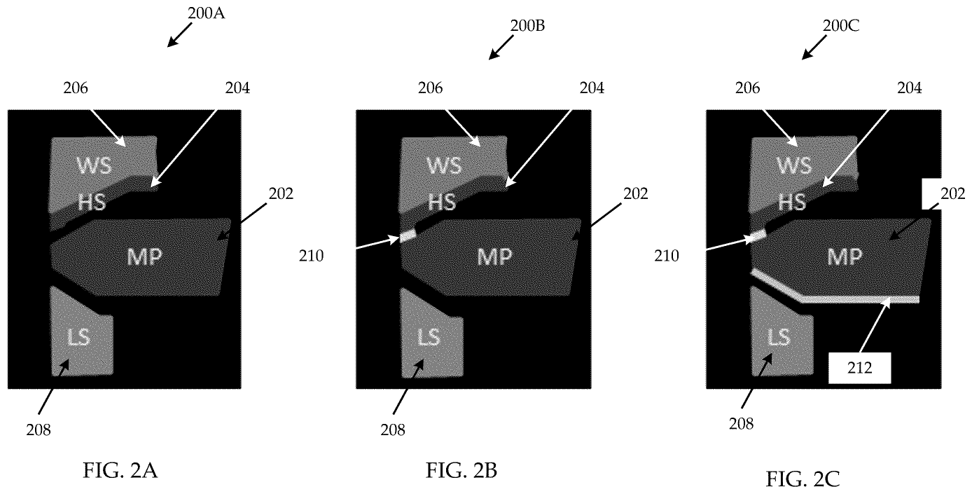

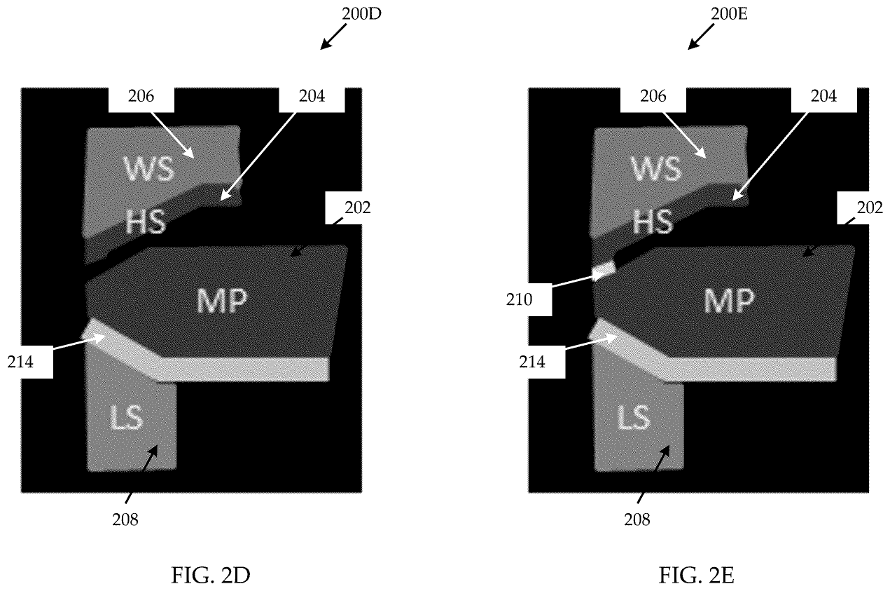

FIGS. 2A-2E illustrate cross-section views of write head designs 200A, 200B, 200C, 200D, 200E. FIGS. 2A-2D can include designs that correspond to FIGS. 1A-1D respectively, while FIG. 2E can correspond with any of FIGS. 1E-1F. For instance, in FIG. 2A, the design 200A can include a M P 202, hot seed (HS) 204, write shield (WS) 206, and a leading shield (LS) 208.

Further, the write head can include a conductive metallic WG 210 between the HS 204 and the M P 202. In some instances, a conductive metallic partial LG 212 can be disposed between the M P 202 and the LS 208, with a dielectric or oxide disposed between the LG 212 and the LS 208. In other examples, a conductive metallic full LG 214 can be disposed between the MP 202 and the LS 208.

For many perpendicular magnetic recording (PM R) writer designs, one common feature is one M P tip to generate the writing field and one hot seed (HS) layer served as the M P flux return path to enhance the writing gradient. For conventional magnetic recording (CM R) aerial density capability (ADC) improvement, it can prefer a small M P tip dimension to achieve high track per inch (TPI) without too much trade-off of writability (OW) and bit per inch (BPI). However, as M P tip dimension is getting smaller reaching ~20-32nm and writing erase width EW is ~25-38 nm, many single MP tip designs can reach their limit.

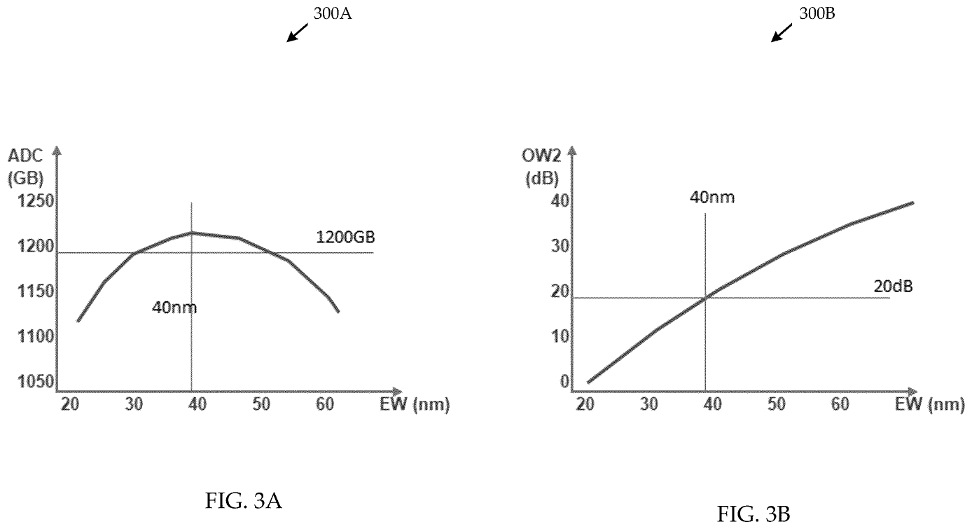

FIGS. 3A-3B illustrate graphical representations 300A, 300B of example A DC and OW2 (the ability to write new data over existing data on the storage media, effectively erasing the old data and replacing it with the new data) dependency on a writing erase width (EW) for various write head designs. As shown in FIG. 3B, OW2, a measurement of low frequency writability, may be unable to get over 20 dB and A DC can start to roll-off at a EW<38 nm. For a shingled magnetic recording (SMR) ADC improvement, track edge writing quality can be essential. With a one MP tip design, track edge curvature may limit the overall SMR ADC achievement especially when EW is smaller. It may be necessary to consider a writer design which can boost narrow EW writability, enhance down track gradient (BPI) and reduce track edge curvature for both CM R and SMR ADC improvement.

The present embodiments describe write head designs with two pole tips (e.g., a dual pole tip (DPT)) connected inside the A BS and separated by a write gap (WG) near the ABS. The design can include a first tip (Tip1) that can remain the primary writing main pole (MP) tip, while a second tip (Tip2) acts as the booster to enhance M P field of Tip1 and adjust MP field edge quality of Tip1. With MP field enhancement, the write head can match media with smaller grain size and higher coercivity and improve both CM R and SMR ADC.

Various views of write head designs are provided with various combinations of the WG, a leading gap (LG), and a side gap (SG) separated by non-conductive oxide layers that can include materials such as aluminum oxide (AlOx), silicon oxide (SiOx), silicon nitride (SiN), aluminum nitride (AlN), magnesium oxide z/(MgO), titanium oxide (TiOx) and tantalum oxide (TaOx), etc., or conductive non-magnetic metallic layers that can include materials such as Ruthenium (Ru), Nichrome (NiCr), Platinum (Pt), Platinum-chromium (PtCr), Tantalum (Ta), Titanium (Ti), etc., or multilayers of partial non-conductive oxide and partial conductive non-magnetic metallic layers. The designs with conductive non-magnetic metallic layers can allow a bias current to flow through Tip1 and Tip2 to have current assist of MP tip switching for more ADC gain.

The WG between top of Tip1 and bottom of Tip2 can have a thickness near the ABS of around 15-27 nm. The WG inside the A BS can be about the same thickness as WG at ABS as that in Wrench DPT and Taper DPT designs as described herein, or become thinner than WG at A BS as shown in a Flat DPT or thicker than WG at A BS as shown in an Antenna DPT as described herein. The WG connection point can be at ~0.2-0.5 μm inside ABS. Tip1 can be made of 24 KG material with dimensions close to a single pole tip (SPT) design, e.g. triangular or trapezoidal shape, with ABS main pole top width PWA ~20-35 nm, ABS main pole thickness PT1 50-100 nm, bevel angle ~7-17 deg from vertical axis at A BS, both leading and trailing edge taper inside ABS as Flat, Antenna and Taper DPT designs, and leading edge taper as Wrench DPT design.

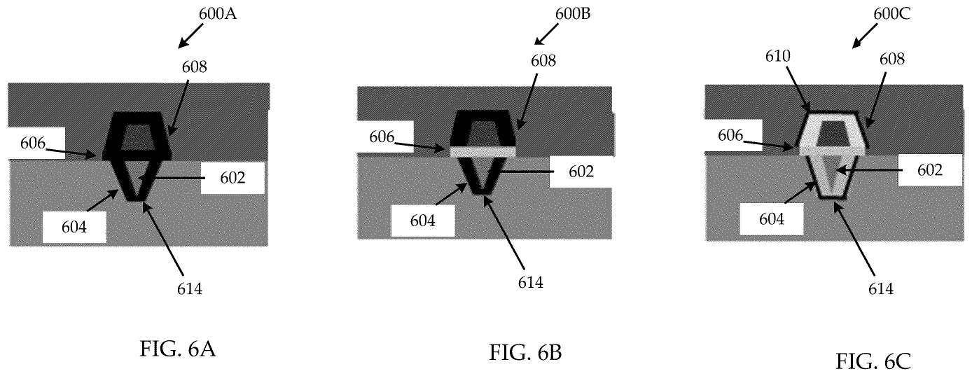

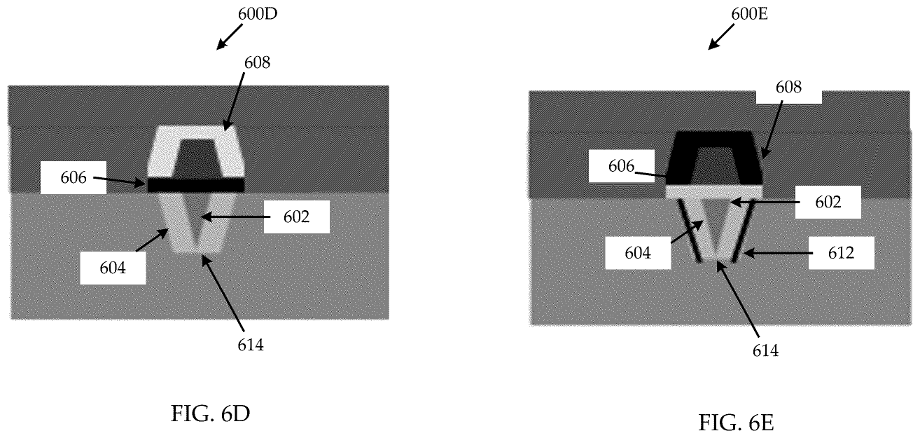

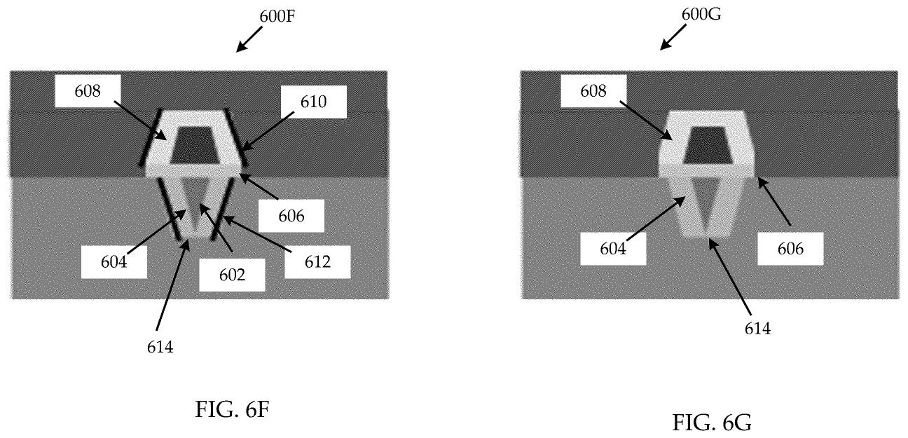

Tip2 can be made of single layer or multilayers of 13 KG to 24 KG materials such as a Nickel Iron (NiFe) alloy, a Nickel Iron and Rhenium (NiFeRe) alloy, a Nickel Iron and Tungsten (NiFeW) alloy, a Cobalt Nickel and Iron (CoNiFe) alloy, an Iron and Cobalt (FeCo) alloy, etc. As a Tip1 field booster, Tip2 can be designed with weaker magnetic field than Tip1. This can be achieved by thinner thickness (e.g. 30-80 nm), larger bevel angle (e.g. 15-25 deg) and better shielding from high moment shielding material, narrower TG, and/or larger shielding volume etc. Bottom width of Tip2 can be slightly wider than Tip1 top pole width, as shown in FIGS. 6A-6G, a Tip2 bottom width can be designed smaller than Tip1 top width to improve track edge curvature or much wider than Tip top width to improve process manufacturability. When Tip2 bottom width is wider than Tip1 top width, magnetic field from Tip2 can be controlled to be lower than Hc1 to eliminate side erasure from the wider Tip2. Tip2 can be flat as Flat DPT design or flat at bottom with taper at trailing side as Wrench DPT design or taper at both top and bottom as Antenna and Taper DPT designs.

Various DPT designs with various electrical connection schemes are describes in the present embodiments. Other DPT designs and other current flowing combinations are also possible when a dual MP tip (DPT) is formed. The present embodiments can provide a higher writability to match with high Hc media with smaller grain size for higher A DC achievement.

M any writer designs can have one pole tip and HS separated by WG. Both pole tip and HS can be made of 24 kG FeCo material. The present embodiments can have two pole tips connected inside ABS and separated by WG near ABS. Tip1 remains as the primary writing MP tip while Tip2 is acting as the booster to enhance MP field of Tip1 and adjust MP field edge quality of Tip1. Tip1 can be made of 24 KG FeCo while Tip2 has the freedom to be single or multilayers of 13 KG to 24 KG materials.

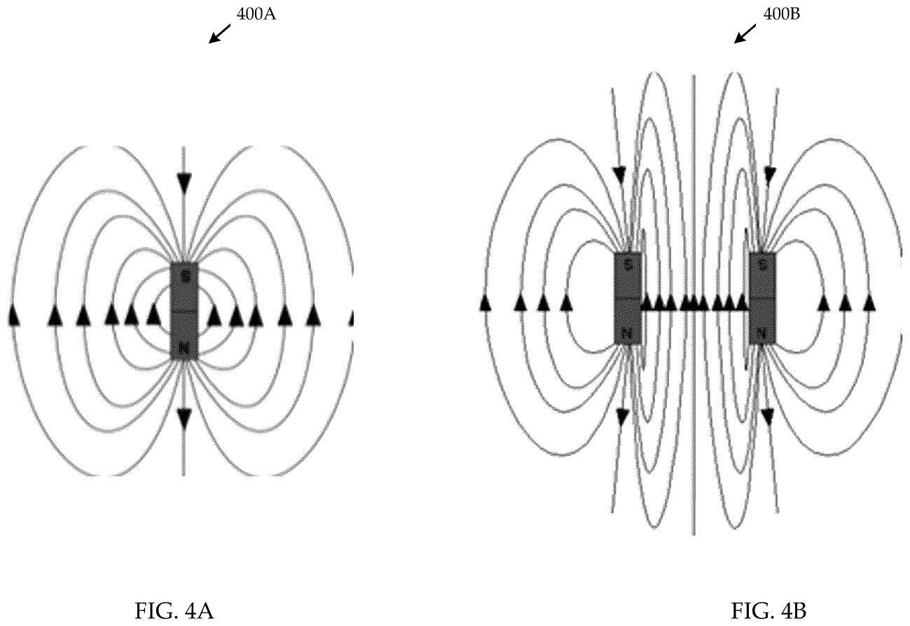

FIGS. 4A-4B illustrate example magnetic field lines 400A, 400B of one bar magnet (FIG. 4A) and two bar magnets in parallel mode (in FIG. 4B). With the same north poles at the bottom and south poles at the top, the field lines between the magnets can be very compact. The field strength can be higher at this area than it would be with one magnet. The field strength and field gradient at the tip regions especially inner tip regions of two magnets can be enhanced comparing to one bar magnet.

A Dual Pole Tip (DPT) writer design can be aimed to boost write field significantly from existing writer designs and allow higher media coercivity (Hc) for a higher recording density. The present designs can replace current HS layer with another pole tip which can be connected to the original MP tip inside ABS. The combination of the original MP tip (Tip1) and the second MP tip (Tip2) at ABS separated by non-magnetic write gap (WG) can enhance writing field from the Tip1.

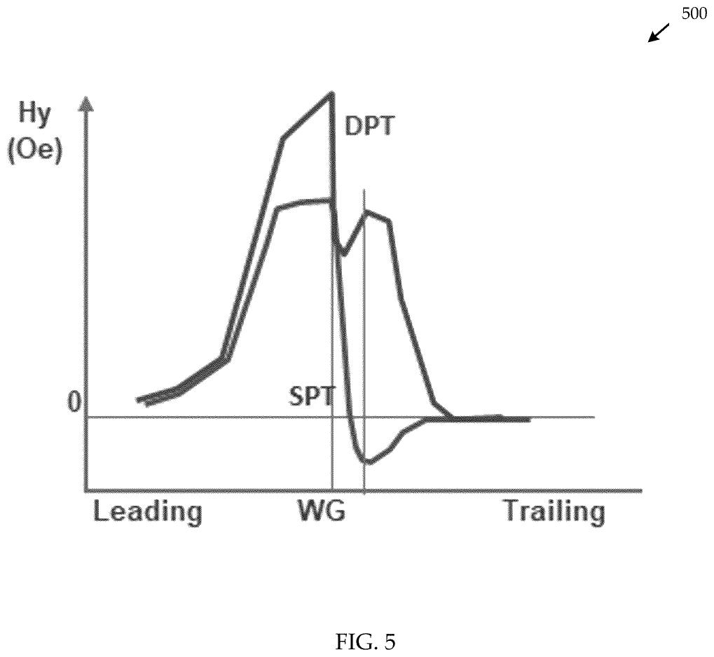

FIG. 5 is an example representation 500 of a down track Hy profile comparison between a single pole tip (SPT) and a dual pole tip (DPT). Due to HS above WG, SPT can have a trailing return field which can drag down the Hy from pole tip significantly. It may help down track gradient but limit media coercivity to Hc0 ~5 kOe and limit overall media A DC capability. To pack more bits in an area with high medium signal to noise ratio (SNR), small grains can be essential. However, small grains can have energy barrier (KV) that are too small to ensure thermal stability of the recorded information. An increase in the anisotropy energy density K increases the required write field.

With a DPT, the booster Tip2, sharing the same polarity of Tip1, can effectively increase Hy from Tip1, offer a higher write field, and allow media coercivity being increased to Hc1~6 kOe or more. High ADC recording can be achieved by controlling Tip1 highest field larger than Hc1(e.g. larger than Hc1+2k Oe), Tip2 highest field to be lower than Hc1 (e.g. Hc1-1 kOe) and WG field farther below Hc1 (e.g. Hc1-1500 to-4500 Oe). For the strongest writability, 24 kG FeCo can be used for Tip1. Since Tip2 is a booster, this can include a 24 KG FeCo or low moment materials such as 16-22 KG FeNi, 19 kG FeCoNi, 13 KG, 15 KG or 18 KG NiFeRe or multi-layers of such 13-24 KG materials.

FIGS. 6A-6G illustrate A BS views of different DPT designs 600A-G. For instance, in FIG. 6A, the design 600A can include a main pole 602, a WG 606, a SG 604 and LG 614, and a TG 608. The WG 606, SG 604 and LG 614, and TG 608 can be non-conductive oxide layers. In FIG. 6B, the WG 606 can include a conductive non-magnetic metallic layer and the SG 604 and LG 614 and TG 608 can be non-conductive oxide layers. In FIG. 6C, the WG 606 can include a conductive non-magnetic metallic layer and the SG 604 and LG 614 and TG 608 can include a combination of a conductive non-magnetic metallic layer and a thin non-conductive oxide layer 610. In FIG. 6D, the WG 606 can be a non-conductive oxide layer and SG 604 and LG 614 and TG 608 can include conductive non-magnetic metallic layers. In FIG. 6E, the WG 606 and the LG 614 can include conductive non-magnetic metallic layer. The SG 604 of Tip1 can include a combination of a conductive non-magnetic metallic layer and a thin non-conductive oxide layer 612, and the TG of Tip2 can include non-conductive oxide layers. In FIG. 6F, the WG 606 and LG 614 can include conductive non-magnetic metallic layer and the SG 604 of Tip1 and side of TG 608 of Tip2 can be a combination of a conductive non-magnetic metallic layer and a thin non-conductive oxide layer 612 in SG 604 and on a side of TG 608. In FIG. 6G, the WG 606 SG and LG 614 and TG 608 can all be non-magnetic conductive metallic layers.

Tip1 can remain as the primary writing MP tip while Tip2 is acting as the booster to enhance MP field of Tip1 and adjust MP field edge quality of Tip1. Tip1 can be close to other designs with triangular or trapezoidal shape and bevel angle ~7-17deg from vertical axis. Tip2 can be on top of Tip1 with triangular or trapezoidal shape but wider width near WG and narrow width away from WG.

As a booster, Tip2 can be designed with weaker magnetic field than Tip1. This can be achieved by thinner thickness, larger bevel angle and better shielding from considering high moment shielding material, narrower TG, and/or larger shielding volume etc. Although the bottom width of Tip2 can be shown as slightly wider than Tip top pole width for illustration purpose, Tip2 bottom width can be designed smaller than Tip1 top width to improve track edge curvature or much wider than Tip1 top width to improve process manufacturability. When Tip2 bottom width is much wider than Tip1 top width, magnetic field from Tip2 can be controlled lower than Hc1 to eliminate side erasure from the wider Tip2. A non-conductive oxide layer can include materials such as AlOx, SiOx, SiN, AlN, MgO, TiOx and TaOx, etc. A conductive non-magnetic metallic layer such as Ru, NiCr, Pt, PtCr, Ta, and Ti etc.

FIG. 6A can include a design without a bias assist feature. FIGS. 6B-6G illustrate various DPT designs that allows DC current passing through shield to MP or MP to shield or even write current passing through M P tip when double driving coil (DDC) design is combined. The DC current can flow from a shield to the MP. Bias current from write shield can pass through WG to MP tip, such as in FIGS. 6B-6C. WG can include the layer between Tip1 top and Tip2 bottom. FIG. 6D can allows current passing through SG 604 of Tip1 and LG 614 which is between Tip1 and leading shield and TG 608 which is between Tip2 and trailing shield. FIG. 6E can have a current flowing through WG and LG only while FIG. 6F can have a current flowing through WG, LG and top of TG. In FIG. 6G, a current can flow from all gaps. Other combinations are also possible as long as dual MP tip (DPT) is formed.

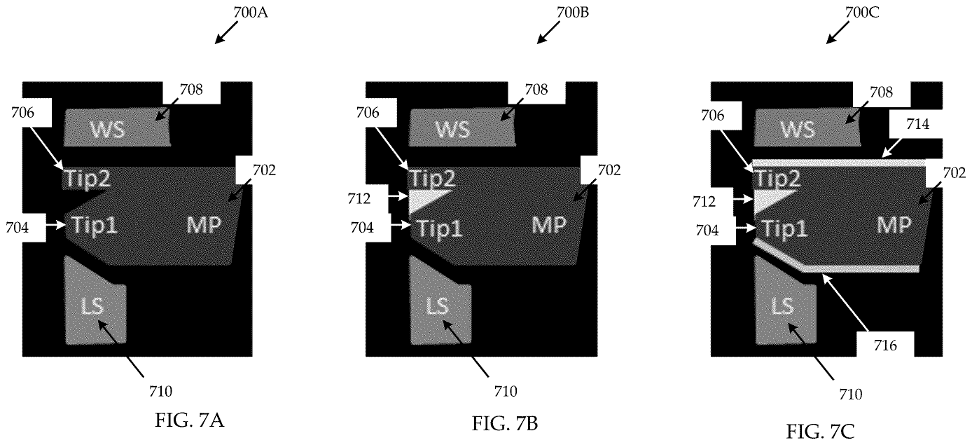

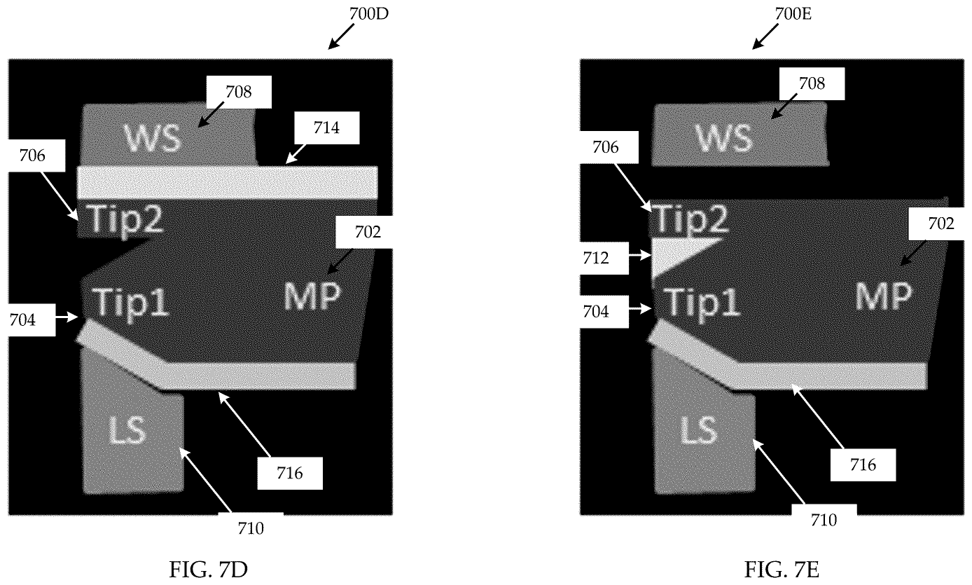

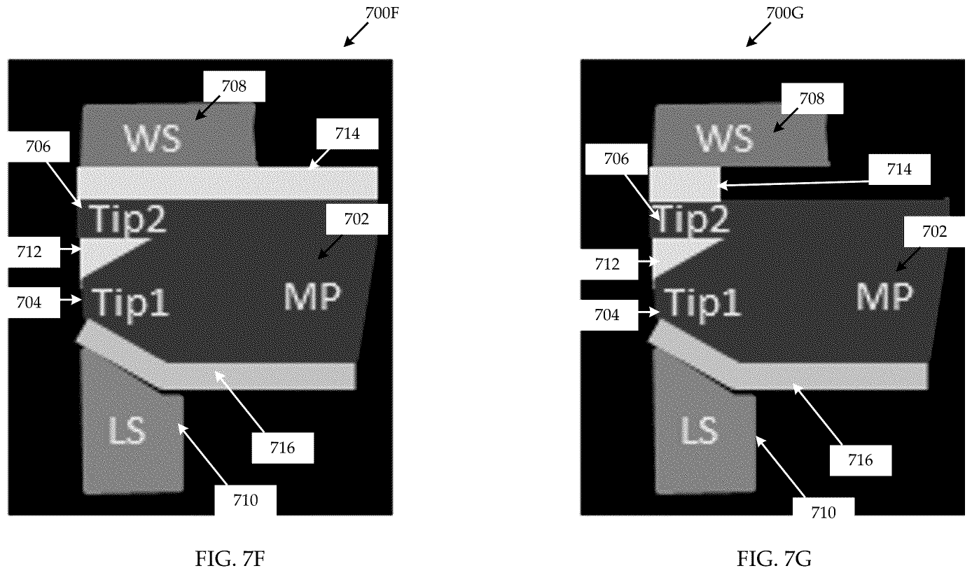

FIGS. 7A-7G illustrate views 700A-G of an example Flat DPT design. For instance, in FIG. 7A, the design can include a M P 702 that includes a first tip 704 and second tip 706, a WS 708, and a LS 710. In FIG. 7A, the WG, LG, and TG can include non-conductive oxide layers. In FIG. 7B, the WG 712 can include conductive non-magnetic metallic layer and the LG and TG can include non-conductive oxide layers. In FIG. 7C, a WG 712 can include a conductive non-magnetic metallic layer and the LG 716 and TG 714 can include a combination of a conductive non-magnetic metallic layer and a thin non-conductive oxide layer. In FIG. 7D, the WG 712 can include a non-conductive oxide layer and the LG 716 and TG 714 can include conductive non-magnetic metallic layers. FIG. 7E can include a WG 712 and LG 716 that include conductive non-magnetic metallic layers, and a TG 714 includes a non-conductive oxide layer. In FIG. 7F, the WG 712, LG 716, and TG 714 can include a conductive non-magnetic conductive metallic layer. In FIG. 7G, the WG 712, LG 716, and TG 714 can include conductive non-magnetic metallic layers but TG contact height can be shorter than WS height.

FIGS. 7A-7G illustrate example cross-section images of one DPT design inside ABS. To differentiate from other DPT design inside A BS, this can be referred to as a Flat DPT as Tip2 can be formed by dry film deposition or plating on a CMP surface and then followed by another CMP process. After Tip2 layer is formed, it can be patterned to an A BS shape followed by Tip2 TG deposition at two sides and top of Tip2 and WS deposition or plating. Tip1 can follow other MP tip processes with leading and trailing edge taper. The leading edge taper can be ranged from 25-40 deg. The trailing edge taper can be tuned from 10-25 deg. A nominal WG thickness at A BS can be ~15-27 nm. The nearest contact point to ABS between Tip1 and Tip2 can be around ~0.1-0.5 μm by tuning trailing edge taper angle and Tip1 trailing edge thickness.

FIGS. 7A-7E can correspond to FIGS. 6A-6E, and FIG. 7F or 7G can correspond to FIGS. 6F and 6G. As Tip2 is flat with uniform thickness, it is good for process controllability to make traperzoidal shape. This design can have the WG variation at ABS depending on lapping finish position, which can require tight control in wafer process and backend lapping.

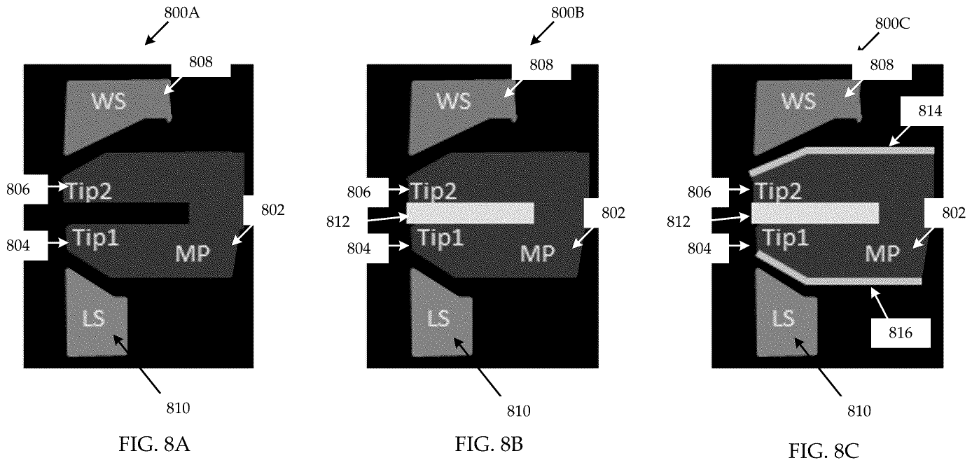

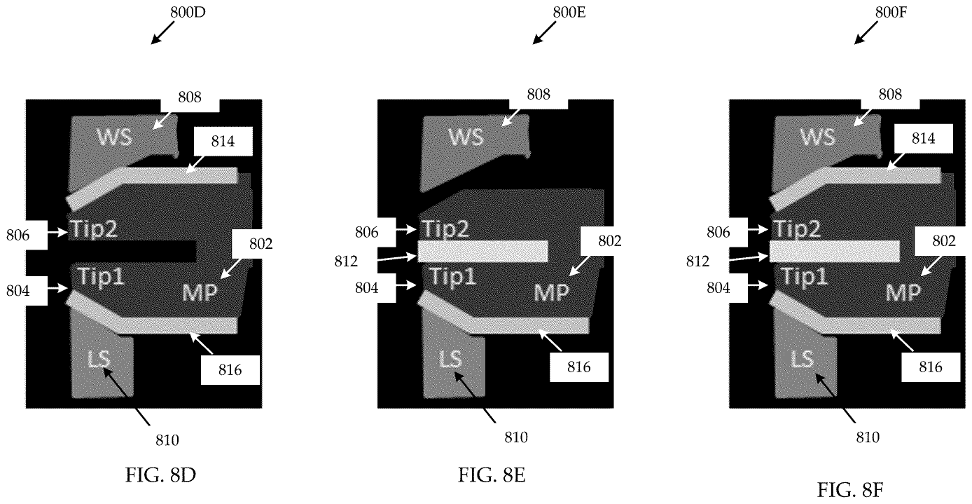

FIGS. 8A-8F illustrate example views 800A-F of a Wrench DPT design. As shown in FIG. 8A, the design can include a MP 802 with a first tip 804 and second tip 806, a WS 808, and a LS 810. Further, in FIG. 8A, any of a Write Gap (WG), Leading Gap (LG), and a Trailing Gap (TG) include non-conductive oxide layers. In FIG. 8B, a WG 812 can include a conductive non-magnetic metallic layer and the LG and TG can include non-conductive oxide layers. In FIG. 8C, the WG 812 can include a conductive non-magnetic metallic layer and the LG 816 and TG 814 can include a combination of a conductive non-magnetic metallic layer and a thin non-conductive oxide layer.

In FIG. 8D, the WG can include a non-conductive oxide layer, and the LG 816 and TG 814 can include conductive non-magnetic metallic layers. In FIG. 8E, the WG 812 and LG 816 can include conductive non-magnetic metallic layers and the TG can include non-conductive oxide layers. In FIG. 8F, the WG 812, LG 816, and TG 814 can include a conductive non-magnetic conductive metallic layer.

Tip1 can follow other M P tip processes with a leading edge taper. After a MP plating, apply MP CMP to a target dimension, Tip1 MP top width PWA ~20-35 nm at ABS and MP thickness PT 1~50-100 nm at ABS, the WG can be deposited on the flat MP surface, chop WG at ~0.2-0.5 μm inside ABS, deposit Tip2 by either dry film process or plating followed by a CMP process, and then form trailing edge taper. The leading edge taper can range from 25-40 deg. The trailing edge taper can be tuned from 10-35 deg. In case trailing gap is filled by conductive non-magnetic metallic layer, trailing edge taper height can be tuned to reach the desired WS to TG contact height. A nominal WG thickness at A BS can be around ~15-27 nm. FIGS. 8A-8E can correspond to FIGS. 6A-6E respectively, while FIG. 8F corresponds to FIGS. 6F and 6G. With the Wrench DPT design, one benefit is WG thickness at A BS being well controlled.

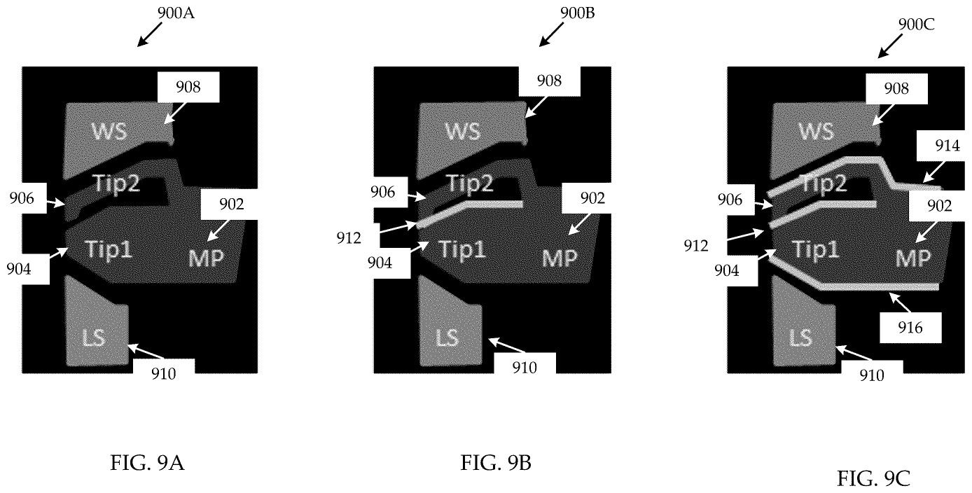

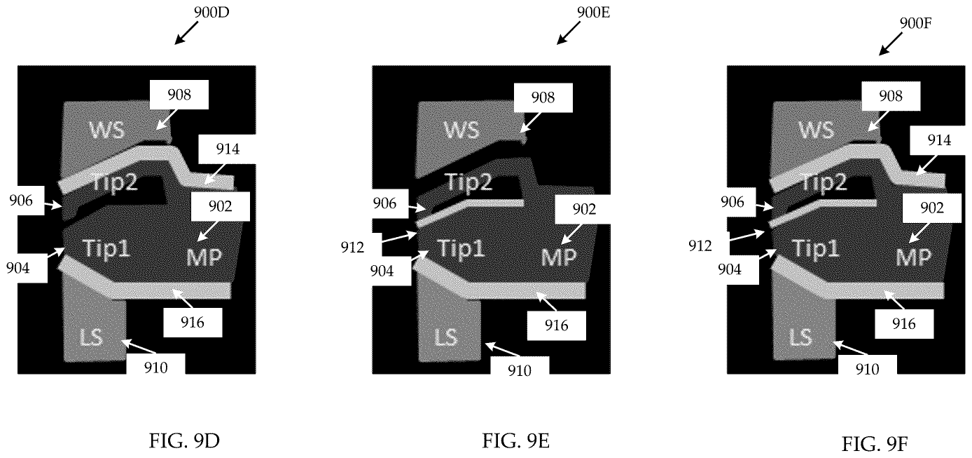

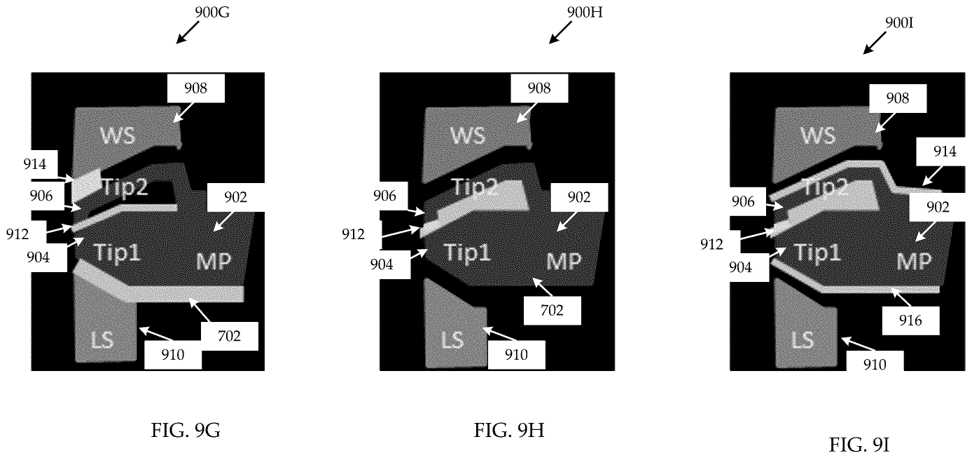

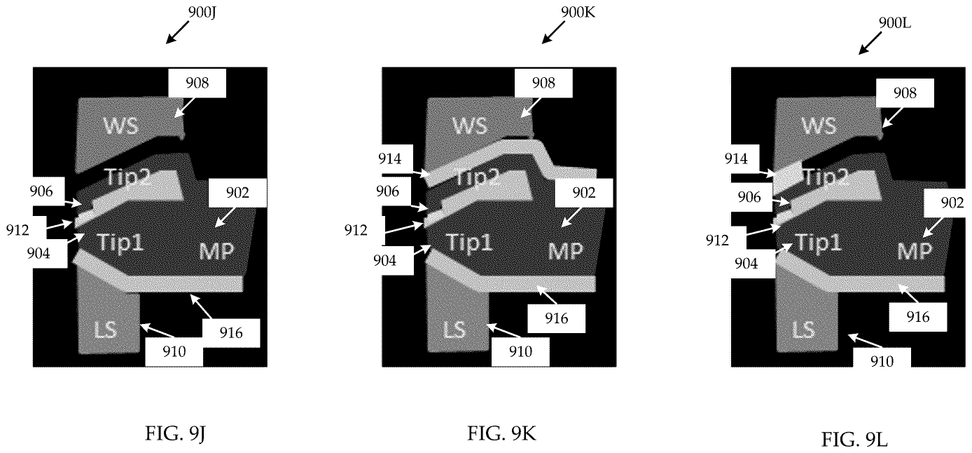

FIGS. 9A-9L illustrate views of example antenna DPT write head designs. For instance, as shown in FIG. 9A, the design 900A can include a main pole 902 that comprises a first tip 904 and a second tip 906 in an antenna design with a taper effective throat (eTH) formed between tip1 904 and tip2 906. Further, a write shield 908 can be formed on a first side of the MP 902, and a leading shield 910 can be formed on a second side of the M P 902. In FIG. 9A, all of the WG, LG, and a TG can be separated by non-conductive oxide layers.

FIGS. 9B and 9H illustrate designs 900B, 900H with a WG separated by a non-magnetic metallic layer 912, while the LG and the TG comprise non-conductive oxide layers, and an eTH can be tapered by a non-conductive oxide layer (in FIG. 9B) and a conductive non-magnetic metallic layer (in FIG. 9H).

FIGS. 9C and 91 illustrate designs 900C, 9001 with a WG 912 comprising a conductive non-magnetic metallic layer, a leading gap (LG) 916 and a Trailing Gap (TG) 914 including a combination of a conductive non-magnetic metallic layer and a thin non-conductive oxide layer. An eTH can be tapered by a non-conductive oxide layer (in FIG. 9C) and a conductive non-magnetic metallic layer (in FIG. 91). In FIG. 9D, the WG and taper eTH can include a non-conductive oxide layer, and the LG 916 and the TG 914 can include conductive non-magnetic metallic layers. FIGS. 9E and 9 include designs 900E, 900) where the WG 912 and LG 916 comprise conductive non-magnetic metallic layers, and a TG 914 including non-conductive oxide layers. An eTH can be tapered by non-conductive oxide layer (in FIG. 9E) and conductive non-magnetic metallic layer (in FIG. 9) . FIGS. 9F, 9G, 9K, and 9L illustrate the WG 912, TG 914, and LG 916 including a conductive non-magnetic conductive metallic layer. The eTH can be tapered by non-conductive oxide layer (in FIGS. 9F-9G) and conductive non-magnetic metallic layer (in FIGS. 9K-9L).

As noted above, FIGS. 9A-9L illustrate cross-section view of a third example DPT design referred to as an Antenna DPT. A first tip (Tip1 904) can be made the same as other SPT heads with both leading and trailing edge taper. After WG (e.g., 912) full film deposition with either non-conductive oxide or conductive non-magnetic metal layer, taper eTH can be formed with either non-conductive oxide layer or conductive non-magnetic metal layer. Then, the two layers inside ABS at ~0.2-0.5 μm away from ABS can be milled away until a MP layer is exposed. The second tip Tip2 906) layer can have a thickness around 30-80 nm and can be deposited on top. Dry film deposition is preferred and the material can be a 13 KG to 24 KG material based on design. Then, Tip2 can be patterned at the ABS and following a Tip1 MP shape inside the A BS. After Tip2 is built, trailing gap TG of Tip2 can be deposited followed by WS1 either by dry film deposition or plating process. The leading edge taper can range from 25-40 deg. The trailing edge taper can be tuned from 10-35 deg. A nominal WG thickness at ABS can be around ~15-27 nm. The taper eTH thickness near A BS can be around ~20-50 nm and gap to flat portion of MP can be around ~100-170 nm.

FIGS. 9A-9E can correspond to FIGS. 6A-6E , while FIGS. 7F and 7G can correspond to FIGS. 6F and 6G. The designs can have non-conductive oxide for taper eTH portion. WG can include non-conductive oxide in FIGS. 9A and 9D, while conductive non-magnetic metal layer can be included in the designs of FIGS. 9B, 9C, and 9E-9L. FIGS. 9H-9L can also have a tapered eTH portion made of conductive non-magnetic metal layer. Tip2 trailing gap can be fully connected with WS by conduction non-magnetic metallic layer, as is shown in FIGS. 9F and 9K, while partially connected with WS by conduction non-magnetic metallic layer, as shown in FIGS. 9G and 9L. For the Antenna DPT design, the WG thickness at the ABS can be well controlled and the Tip1 can reach the maximum performance that a pole tip can get to from optimized leading and trailling edge taper and narrow gap to Tip2 at A BS and wider gap inside ABS.

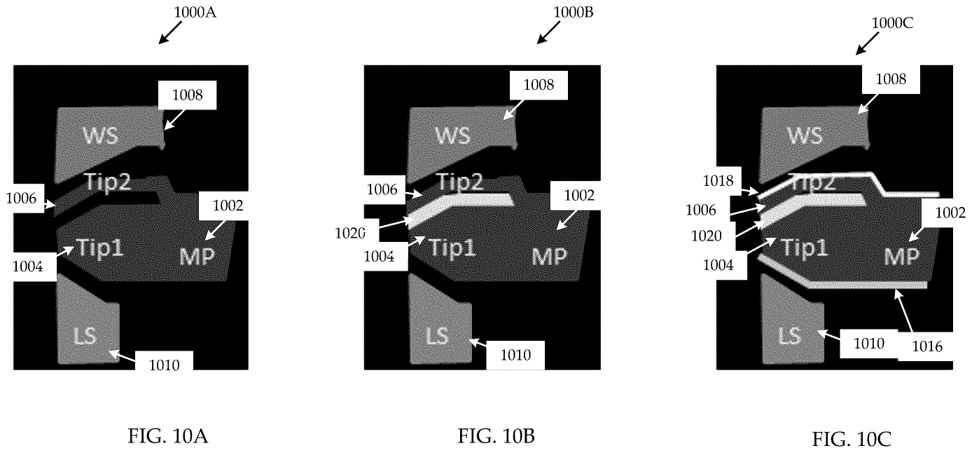

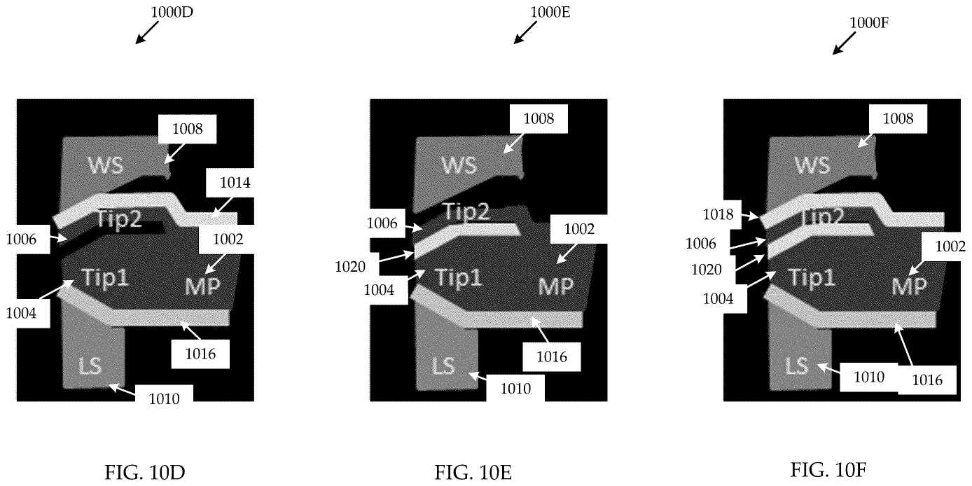

FIGS. 10A-F illustrate example taper DPT designs 1000A-F. As shown in FIG. 10A, the design 1000A can include a MP 1002 with a first tip 1004 and a second tip 1006. Further, a WS 1008 can be disposed on a first side of the MP 1002 and a LS 1010 can be disposed on a second side of the M P 1002. Further, in FIG. 10A, any of a WG, LG, and TG can include non-conductive oxide layers. In FIG. 10B, a WG 1020 can include a conductive non-magnetic metallic layer, while the LG and the TG can include non-conductive oxide layers. In FIG. 10C, the WG 1020 can include a conductive non-magnetic metallic layer, while the LG 1016 and the TG 1018 can include a combination of a conductive non-magnetic metallic layer and a thin non-conductive oxide layer. In FIG. 10D, a WG can include a non-conductive oxide layer, while the LG 1016 and the TG 1014 can include conductive non-magnetic metallic layers. In FIG. 10E, a WG 1020 and a LG 1016 can include conductive non-magnetic metallic layers and the TG can include non-conductive oxide layers. In FIG. 10F, all of the WG 1020, a LG 1016, and a TG 1014 can include a conductive non-magnetic conductive metallic layer.

FIGS. 10A-F illustrate views of an example DPT design referred to as a Taper DPT. In this design, after a first tip (Tip1 1004) is formed with correct MP dimension along with leading and trailing edge tapers, a WG of around ~15-27 nm can be deposited, and the WG can be chopped inside A BS at ~0.2-0.5 μm, a Tip2 can be deposited on top of WG and MP top by dry film deposition. The Tip 2 can be a single or multilayers of 13 KG to 24 KG materials with a thickness around 30-80 nm. Tip2 can be patterned to an ABS view at ABS and following Tip1 MP shape inside ABS. After Tip2 is built, trailing gap TG of Tip2 can be deposited followed by a first write shield (e.g., WS1) either by dry film deposition or plating process. FIGS. 10A-10E can correspond to FIGS. 6A-6E, while FIG. 7F can correspond to either of FIGS. 6F-6G.

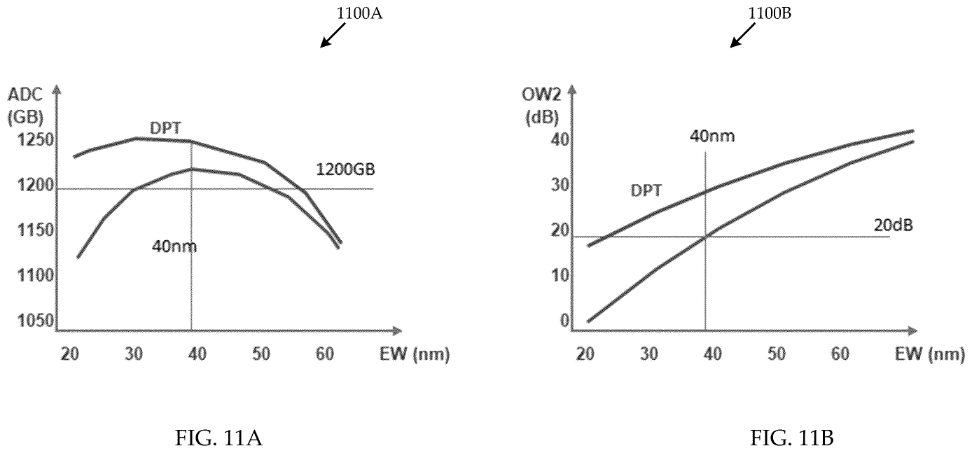

FIGS. 11A-B illustrates DPT gain over SPT in A DC and OW2. With stronger field at Tip1 from DPT, OW2 is expected better than SPT especially at narrow EW. Media can be tuned to have higher Hc for smaller grain size and better ADC.

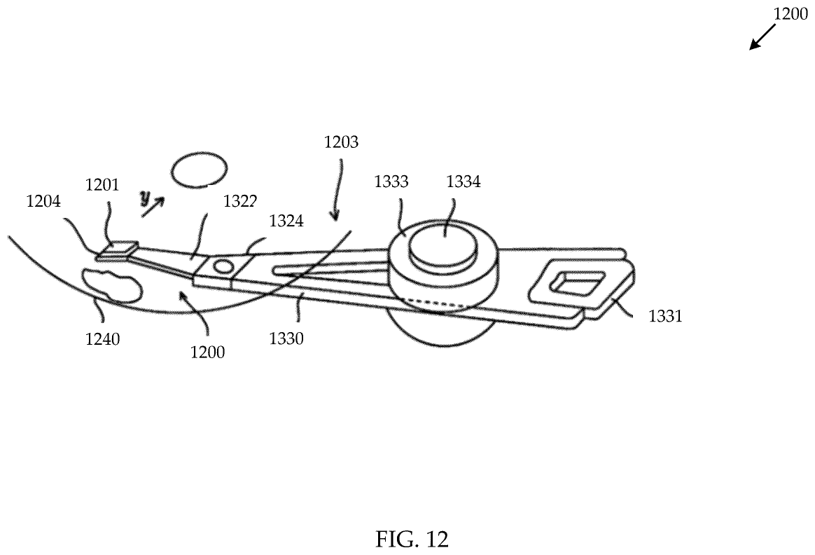

The write head as described herein can be part of a hard disk drive (HDD) system. For instance, the write head can include a slider and a write structure as described herein, with a suspension configured to support the write head. FIG. 12 is a perspective view of an example head arm assembly 1200, according to some embodiments of the present disclosure. The write head as described herein can be part of an assembly comprising components as described with respect to FIGS. 12-14.

Referring to FIG. 12, a head arm assembly (or Head Gimbal Assembly (HGA)) 1200 includes a magnetic recording head 1201 comprised of a slider and a PM R writer structure formed thereon, and a suspension 1203 that elastically supports the magnetic recording head.

The suspension has a plate spring-like load beam 1322 formed with stainless steel, a flexure 1204 provided at one end portion of the load beam, and a base plate 1324 provided at the other end portion of the load beam. The slider portion of the magnetic recording head is joined to the flexure, which gives an appropriate degree of freedom to the magnetic recording head. A gimbal part (not shown) for maintaining a posture of the magnetic recording head at a steady level is provided in a portion of the flexure to which the slider is mounted.

HGA 1200 is mounted on an arm 1330 formed in the head arm assembly. The arm moves the magnetic recording head 1201 in the cross-track direction y of the magnetic recording medium 1240. One end of the arm is mounted on base plate 1324. A coil 1331 that is a portion of a voice coil motor is mounted on the other end of the arm. A bearing part 1333 is provided in the intermediate portion of arm 1330. The arm is rotatably supported using a shaft 1334 mounted to the bearing part 1333. The arm 1330 and the voice coil motor that drives the arm configure an actuator.

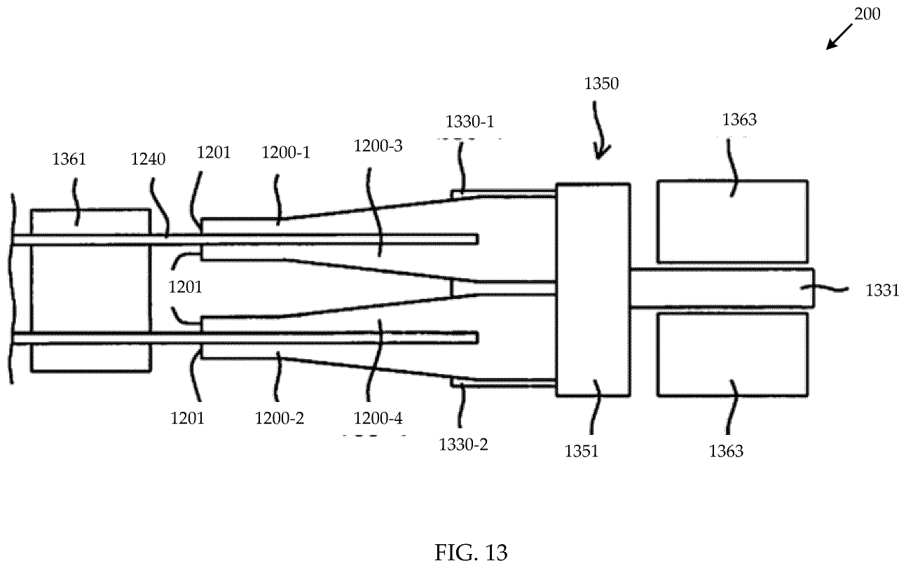

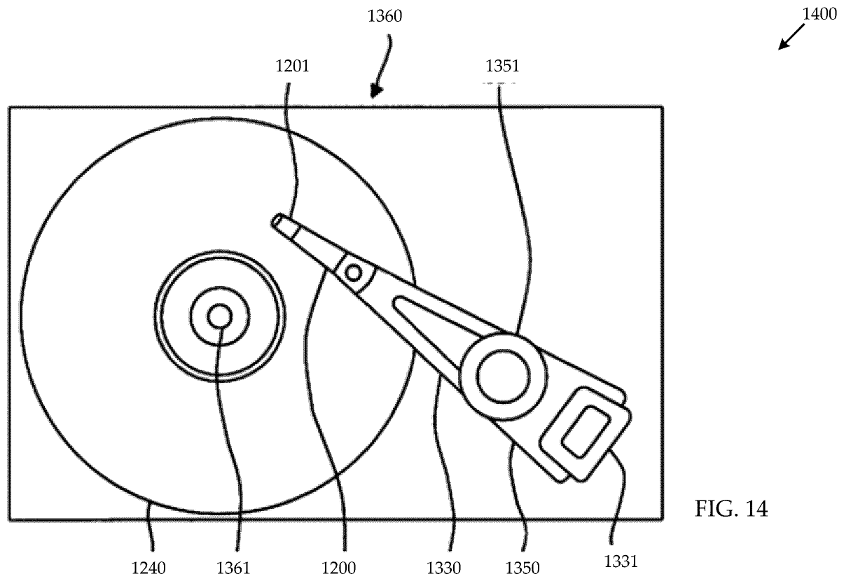

Next, a side view 1300 of a head stack assembly (FIG. 13) and a plan view 1400 of a magnetic recording apparatus (FIG. 14) wherein the magnetic recording head 1201 is incorporated are depicted. The head stack assembly 1350 is a member to which a plurality of HGAs (HGA 1200-1 and second HGA 1200-2 are at outer positions while HGA 1200-3 and HGA 1200-4 are at inner positions) is mounted to arms 1330-1, 1330-2, respectively, on carriage 1351. A HGA is mounted on each arm at intervals so as to be aligned in the perpendicular direction (orthogonal to magnetic medium 1240). The coil portion (1231 in FIG. 12) of the voice coil motor is mounted at the opposite side of each arm in carriage 1351. The voice coil motor has a permanent magnet 1363 arranged at an opposite position across the coil 1331.

With reference to FIG. 14, the head stack assembly 1350 is incorporated in a magnetic recording apparatus 1360. The magnetic recording apparatus has a plurality of magnetic media 1240 mounted to spindle motor 1361. For every magnetic recording medium, there are two magnetic recording heads arranged opposite one another across the magnetic recording medium. The head stack assembly and actuator except for the magnetic recording heads 1201 correspond to a positioning device, and support the magnetic recording heads, and position the magnetic recording heads relative to the magnetic recording medium. The magnetic recording heads are moved in a cross-track of the magnetic recording medium by the actuator. The magnetic recording head records information into the magnetic recording media with a PMR writer element (not shown) and reproduces the information recorded in the magnetic recording media by a magneto-resistive (MR) sensor element (not shown).

In a first example embodiment, a write head is provided. The write head can include a main pole (MP) configured to be disposed at an air-bearing surface (ABS). The MP can include a first tip portion configured as a primary writing tip and a second tip portion acting as a booster to enhance a magnetic field of the first tip portion. The write head can also include a write gap (WG) formed between the first tip portion and the second tip portion. a write shield (WS) disposed on a first side of the MP. The write head can also include a trailing gap (TG) between the WS and the second tip portion of the MP, a leading shield (LS) disposed on a second side of the MP, and a leading gap (LG) between the LS and the first tip portion of the MP.

In some instances, the WG comprises a trapezoidal shape.

In some instances, the WG comprises a rectangular shape with a length of the WG greater than a thickness of the WG.

In some instances, the WG comprises an angled shape with a length of the WG greater than a thickness of the WG.

In some instances, the WG comprises a thickness ranging between around 15-27 nanometers (nm).

In some instances, a thickness of the first tip portion ranges between around 50-100 nm and a thickness of the second tip portion ranges between around 30-80 nm.

In some instances, any of the WG, TG, and LG comprise a non-conductive oxide layer, and the non-conductive oxide layer comprises any of aluminum oxide (AlOx), silicon oxide (SiOx), silicon nitride (SiN), aluminum nitride (AlN), magnesium oxide (MgO), titanium oxide (TiOx) and tantalum oxide (TaOx).

In some instances, any of the WG, TG, and LG comprise a conductive non-magnetic metallic layer that comprises any of Ruthenium (Ru), Nichrome (NiCr), Platinum (Pt), Platinum-chromium (PtCr), Tantalum (Ta), and Titanium (Ti).

In some instances, any of the LG and TG comprise a combination of a conductive non-magnetic metallic layer and a non-conductive oxide layer comprising a thickness less than that of the conductive non-magnetic metallic layer.

In another example embodiment, a device is provided. The device can include a main pole (MP) comprising a first tip portion and a second tip portion disposed adjacent to the first tip portion. The device can also include a write gap (WG) formed between the first tip portion and the second tip portion. The device can also include a trailing gap (TG) disposed adjacent to the second tip portion of the M P and a leading gap (LG) disposed adjacent to the first tip portion of the MP.

In some instances, the device also includes a write shield (WS) disposed adjacent to the TG and a leading shield (LS) disposed adjacent to the LG.

In some instances, the WG comprises a trapezoidal shape.

In some instances, the WG comprises a rectangular shape with a length of the WG greater than a thickness of the WG.

In some instances, any of the WG, TG, and LG comprise a non-conductive oxide layer or conductive non-magnetic metallic layer.

In some instances, the WG comprises the non-conductive oxide layer and the TG and LG comprise conductive non-magnetic metallic layers.

In some instances, the WG comprises the conductive non-magnetic metallic layer and the TG and LG comprise non-conductive oxide layers.

In another example embodiment, a method is provided. The method can include forming a main pole (MP). Forming the M P can include forming a first tip portion of the MP and depositing a write gap (WG) over the surface of the main pole. Forming the MP can also include forming a second tip portion of the MP as being disposed over the WG, patterning the second tip portion by any of a dry film deposition or a chemical mechanical planarization (CMP) process, and forming a trailing edge taper on the M P. The method can also include disposing a leading gap (LG) adjacent to the first tip portion of the M P and disposing a trailing gap (TG) adjacent to the second tip portion of the MP. The method can also include disposing a write shield (WS) adjacent to the TG and disposing a leading shield (LS) adjacent to the LG.

In some instances, any of the WG, TG, and LG comprise a non-conductive oxide layer, wherein the non-conductive oxide layer comprises any of aluminum oxide (AlOx), silicon oxide (SiOx), silicon nitride (SiN), aluminum nitride (AlN), magnesium oxide (MgO), titanium oxide (TiOx) and tantalum oxide (TaOx), and, wherein any of the WG, TG, and LG comprise a conductive non-magnetic metallic layer that comprises any of Ruthenium (Ru), Nichrome (NiCr), Platinum (Pt), Platinum-chromium (PtCr), Tantalum (Ta), and Titanium (Ti).

In some instances, the method can also include patterning the WG to form the WG into any of a trapezoidal shape and a rectangular shape.

In some instances, any of the LG and TG comprise a combination of a conductive non-magnetic metallic layer and a non-conductive oxide layer comprising a thickness less than that of the conductive non-magnetic metallic layer.

It will be understood that terms such as “top,” “bottom,” “above,” “below,” and x-direction, y-direction, and z-direction as used herein as terms of convenience that denote the spatial relationships of parts relative to each other rather than to any specific spatial or gravitational orientation. Thus, the terms are intended to encompass an assembly of component parts regardless of whether the assembly is oriented in the particular orientation shown in the drawings and described in the specification, upside down from that orientation, or any other rotational variation.

It will be appreciated that the term “present invention” as used herein should not be construed to mean that only a single invention having a single essential element or group of elements is presented. Similarly, it will also be appreciated that the term “present invention” encompasses a number of separate innovations, which can each be considered separate inventions. Although the present invention has been described in detail with regards to the preferred embodiments and drawings thereof, it should be apparent to those skilled in the art that various adaptations and modifications of embodiments of the present invention may be accomplished without departing from the spirit and the scope of the invention. Accordingly, it is to be understood that the detailed description and the accompanying drawings as set forth hereinabove are not intended to limit the breadth of the present invention, which should be inferred only from the following claims and their appropriately construed legal equivalents.

1. A write head comprising:
a main pole (MP) configured to be disposed at an air-bearing surface (ABS), the MP comprising a first tip portion configured as a primary writing tip and a second tip portion that are both disposed at the ABS, the second tip portion acting as a booster to enhance a magnetic field of the first tip portion;
a write gap (WG) formed between the first tip portion and the second tip portion;
a write shield (WS) disposed on a first side of the MP;
a trailing gap (TG) between the WS and the second tip portion of the MP;
a side shield (SS) disposed at each of a first side and a second side sides of the first tip portion of the MP;
a side gap (SG) disposed between the SS and the first tip portion of the MP;
a leading shield (LS) disposed on a second side of the MP; and
a leading gap (LG) between the LS and the first tip portion of the MP.

2. The write head of claim 1, wherein the WG comprises a trapezoidal shape.

3. The write head of claim 1, wherein the WG comprises a rectangular shape with a length of the WG greater than a thickness of the WG.

4. The write head of claim 1, wherein the WG comprises an angled shape with a length of the WG greater than a thickness of the WG.

5. The write head of claim 1, wherein the WG comprises a thickness ranging between around 15-27 nanometers (nm).

6. The write head of claim 1, wherein a thickness of the first tip portion ranges between around 50-100 nm and a thickness of the second tip portion ranges between around 30-80 nm.

7. The write head of claim 1, wherein any of the WG, TG, SG and LG comprise a non-conductive oxide layer, wherein the non-conductive oxide layer comprises any of aluminum oxide (AlOx), silicon oxide (SiOx), silicon nitride (SiN), aluminum nitride (AlN), magnesium oxide (MgO), titanium oxide (TiOx) and tantalum oxide (TaOx).

8. The write head of claim 1, wherein any of the WG, TG, SG and LG comprise a conductive non-magnetic metallic layer that comprises any of Ruthenium (Ru), Nichrome (NiCr), Platinum (Pt), Platinum-chromium (PtCr), Tantalum (Ta), and Titanium (Ti).

9. The write head of claim 1, wherein any of the LG, SG and TG comprise a combination of a conductive non-magnetic metallic layer and a non-conductive oxide layer comprising a thickness less than that of the conductive non-magnetic metallic layer.

10. A device comprising:
a main pole (MP) comprising a first tip portion and a second tip portion that are both disposed at the ABS, the second tip portion disposed adjacent to the first tip portion;
a write gap (WG) formed between the first tip portion and the second tip portion;
a trailing gap (TG) disposed adjacent to the each of a first side, a second side, and a third side of the second tip portion of the MP;
a side gap (SG) disposed adjacent to a first side and a second side of first tip portion of the MP; and
a leading gap (LG) disposed adjacent to the third side of first tip portion of the MP.

11. The device of claim 10, further comprising:
a write shield (WS) disposed adjacent to the TG;
a side shield (SS) disposed adjacent to the SG; and
a leading shield (LS) disposed adjacent to the LG.

12. The device of claim 10, wherein the WG comprises a trapezoidal shape.

13. The device of claim 10, wherein the WG comprises a rectangular shape with a length of the WG greater than a thickness of the WG.

14. The device of claim 10, wherein any of the WG, TG, SG and LG comprise a non-conductive oxide layer or conductive non-magnetic metallic layer.

15. The device of claim 10, wherein the device is part of a head arm assembly, wherein the device is connected to a slider and a load beam, wherein the load beam is connected to a suspension configured to support the device and the slider.

16. A method comprising:
forming a main pole (MP) of a device by:
disposing a leading shield (LS) with a leading edge taper comprising an angle of between around 25 to 40 degrees;
disposing a side shield (SS) on top of the LS, the SS forming a trapezoidal opening at a center of the SS, wherein a width of the SS at a first side facing the LS is less than a width of the SS at a second side, the SS comprising a bevel angle of between around 7 to 17 degrees from a vertical axis;
disposing a side gap (SG) and a leading gap (LG) inside the trapezoidal opening formed in the SS;
forming a first tip portion of the MP disposed inside the SG and the LG;
depositing a write gap (WG) over the main pole;
forming a second tip portion of the MP as being disposed over the WG;
patterning the second tip portion by any of a dry film deposition or a chemical mechanical planarization process;
forming a trailing edge taper on the MP;
disposing a trailing gap (TG) adjacent to the second tip portion of the MP; and
disposing a write shield (WS) adjacent to the TG.

17. The method of claim 16, wherein any of the WG, TG, and LG comprise a non-conductive oxide layer, wherein the non-conductive oxide layer comprises any of aluminum oxide (AlOx), silicon oxide (SiOx), silicon nitride (SiN), aluminum nitride (AlN), magnesium oxide (MgO), titanium oxide (TiOx) and tantalum oxide (TaOx), and wherein any of the WG, TG, and LG comprise a conductive non-magnetic metallic layer that comprises any of Ruthenium (Ru), Nichrome (NiCr), Platinum (Pt), Platinum-chromium (PtCr), Tantalum (Ta), and Titanium (Ti).

18. The method of claim 16, further comprising:
patterning the WG to form the WG into any of a trapezoidal shape and a rectangular shape.

19. The method of claim 16, wherein any of the LG, SG and TG comprise a combination of a conductive non-magnetic metallic layer and a non-conductive oxide layer comprising a thickness less than that of the conductive non-magnetic metallic layer.

20. The method of claim 16, further comprising:
connecting the device to a slider, the device and the slider comprising a recording head;
connecting the recording head to a load beam; and
connecting a suspension to the load beam, wherein the suspension is configured to support the recording head.
